(19) United States
(12) Patent Application Publication
(10) Pub. No.: US 2010/0202247 A1
(43) Pub. Date: Aug. 12, 2010

(54) DEVICE FOR PROCESSING MOLECULAR CLUSTERS OF LIQUID TO NANO-SCALE

(75) Inventor: CHUAN-HSING PAN, Fengshan City (TW)

Correspondence Address: Flash Intellectual Property, Inc.;Attn. Cheng-Ju Chiang, P.O. Box 766, Chino, CA, 91708, US

(73) Assignee: SHENNONGSHIN NANOTECHNOLOGY CO., LTD., Niaosong Shiang (TW)

(21) Appl. No.: 12/701,541

(22) Filed: Feb. 6, 2010

(30) Foreign Application Priority Data
Feb. 6, 2009 (TW) 098103933

(51) Int. Cl. B01F 7/04

(52) U.S. Cl. 366/261; 977/832; 977/900

(57) ABSTRACT

A device for processing molecular clusters of a liquid to nano-scale is provided and includes a stirring chamber having a hexagonal (or octagonal) column space; a plurality of first stirring modules, each of which has at least one first stirring blade having a left-handed swastika shape (or right-handed swastika shape) for pushing a liquid to flow; and a plurality of second stirring modules, each of which has at least one second stirring blade having a right-handed swastika shape (or left-handed swastika shape) for pushing the liquid to reversely flow. Thus, molecular clusters of the liquid are collided with each other under a condition with high temperature, high pressure and high stirring speed, until the particle diameter of the molecular clusters is reduced to a nano-scale.

### FIELD OF THE INVENTION

The present invention relates to a device for processing molecular clusters of liquid to nano-scale, and more particularly to a device having a stirring chamber and stirring blades with special shape designs for processing molecular clusters of liquid to nano-scale.

### BACKGROUND OF THE INVENTION

Water (H₂O) is an inorganic molecule composed of hydrogen element and oxygen element, and water is a colorless and odorless transparent liquid at room temperature under atmospheric pressure. Water is the most common substance on earth, while water is an essential component for all organisms including humans to maintain physiological functions and carry out biochemical reactions. Water can be transformed between liquid phase, gaseous phase and solid phase. Due to intermolecular forces, a molecular cluster of normal water is composed of 13-16 water molecules, all of which constructs a macromolecular group of cyclic structure. Thus, the surface tension of water (71.96 dyne/cm) is considerable, and water can provide apparent capillary phenomena and adsorption phenomena. Purified water only has very weak conductivity and the pH value thereof is about 7.35, i.e. weak alkaline.

Recently, related researches found that molecular clusters of water can be collided with each other to miniaturize the particle diameter thereof by mixing and disturbing liquid-phase water via suitable stirring blades. After the molecular clusters of water are collided with each other, an original macromolecular cluster of cyclic structure composed of 13-16 water molecules is converted into a smaller molecular cluster composed of fewer water molecules, wherein the amount of water molecules of the smaller molecular cluster is varied according to various parameter settings of a collision processing device. When a normal molecular cluster of water is converted into a nano-scale molecular cluster of water, some physical analyses found that physical and chemical properties of nano-scale water (i.e. water having nano-scale molecular clusters) are different from that of normal water. For example, the pH value of nano-scale water is converted into 10-12, i.e. alkaline, wherein the reason may be that oxygen originally dissolved in water reacts with water to form hydroxyl (OH⁻) group which causes alkaline water during the molecular clusters of water are collided with each other. Furthermore, the surface tension of nano-scale water is lowered. For example, when normal water is dropped onto a leaf, normal water can form a droplet due to cohesion. However, when nano-scale water is dropped onto a leaf, nano-scale water can not form a droplet, but nano-scale water can wet the leaf. Especially, because the molecular clusters of nano-scale water are smaller, nano-scale water can rapidly pass through cellular membranes to enter blood vessels and be dissolved into lipids, while more solutes can be dissolved into nano-scale water. Thus, nano-scale water can enhance the metabolism and excretion of various biological molecules including lipids. Because nano-scale water has the foregoing physical and chemical properties, nano-scale water can be applied to various technological fields, such as drinking water, medicine, cosmetics, diet products, health foods, alcohols and cleaners.

When the amount of water molecules in a molecular cluster of nano-scale water is reduced, the particle diameter of the molecular cluster will be smaller, and the physical and chemical properties thereof (such as permeability) will thus be better. Thus, it is important for related researchers to think how to develop a suitable collision processing device for processing molecular clusters of normal water into the molecular clusters of nano-scale water and miniaturize the molecular clusters of nano-scale water as possible. Presently, the nano-scale water generated by various commercially available collision processing device of molecular clusters of water can be analyzed by N4 Plus Submicron Particle Size Analyzer (Beckman Coulter, U.S.A.), wherein the particles in liquid, colloid and suspension and molecules or molecular clusters having particle diameter greater than 3-3000 nanometer (nm) in liquid are analyzed by using spectrophotometry to measure the diffusivity of foregoing samples, so as to calculate various parameters, such as average particle size, distribution of particle size and distribution of molecular weight. For example, the particle size of molecular clusters of normal tap water or bottled water is about 3900-4200 nm, while the particle size of molecular clusters of nano-scale water processed by the commercially available collision processing device of molecular clusters of water can be miniaturized to about 200 nm. When the particle size of molecular clusters is lowered, the amount of linked water molecules is reduced, the bonding linkage is shorter, and the molecular cluster is smaller. Meanwhile, the permeability, solubility and dissolved oxygen of water are increased, i.e. the quality of water becomes better, so that the processed water molecules is advantageously absorbed and used by human body for improving nutrients absorption and metabolic cycle therein.

However, various traditional collision processing devices of molecular clusters of water are limited to mechanical structures thereof, and thus can not generate more nano-scale water. Meanwhile, the percentage of the small molecular clusters in the nano-scale water can not be further efficiently increased, i.e. most content of the nano-scale water is still large molecular clusters. As a result, it is important to improve the traditional collision processing devices of molecular clusters of water to carry out the mass production of nano-scale water having smaller molecular clusters.

### SUMMARY OF THE INVENTION

A primary object of the present invention is to provide a device for processing molecular clusters of liquid to nano-scale, wherein a stirring chamber has a hexagonal (or octagonal) column space, while a plurality of stirring blades have a [symbol] shape or a [symbol] shape (i.e. a left-handed swastika shape or a right-handed swastika shape) for increasing the collision frequency of molecular clusters of the liquid, so as to advantageously reduce the amount of linked water molecules and the particle size of the molecular clusters for processing the molecular clusters of the liquid to nano-scale. Thus, a nano-scale liquid having better physical and chemical properties can be obtained, and the mass production of nano-scale liquid can be carried out.

A secondary object of the present invention is to provide a device for processing molecular clusters of liquid to nano-scale, wherein three (or four) first stirring modules are used to push a liquid to flow, while three (or four) second stirring modules which are alternatively arranged with the first stirring modules and located at different heights are used to push the liquid to reversely flow. Thus, the molecular clusters of the liquid are collided with each other under high stirring speed, and thus the molecular clusters are broken into smaller molecular clusters with smaller particle diameter, so as to increase the collision frequency of the molecular clusters of the liquid.

A third object of the present invention is to provide a device for processing molecular clusters of liquid to nano-scale, wherein six (or eight) stirring modules are used to push a liquid to flow along two opposite directions under high stirring speed and to collide with each other to generate high temperature. Thus, smaller molecular clusters of the liquid with smaller particle diameter can be obtained, so as to enhance the processing efficiency of processing molecular clusters of liquid to nano-scale.

To achieve the above object, the device for processing molecular clusters of liquid to nano-scale of a preferred embodiment of the present invention comprises a stirring tank, a plurality of first stirring modules and a plurality of second stirring modules. The stirring tank has a liquid inlet for inputting a liquid and a hexagonal (or octagonal) stirring chamber for receiving the liquid. The first stirring modules and the second stirring modules are alternatively arranged on a plurality of angular positions in the stirring chamber, respectively. Each of the first stirring modules has a first driving unit, a first shaft and at least one first stirring blade. The first stirring blade has a [symbol] shape (or [symbol] shape), and the first driving unit is used to drive the first stirring blade to rotate for pushing the liquid to flow along a first direction under high stirring speed through the first shaft. Each of the second stirring modules has a second driving unit, a second shaft and at least one second stirring blade. The second stirring blade has a [symbol] shape (or [symbol] shape), and the second driving unit is used to drive the second stirring blade to rotate for pushing the liquid to flow along a second direction opposite to the first direction under high stirring speed through the second shaft. Thus, molecular clusters of the liquid flowing along the first and second directions are collided with each other under high stirring speed, until the particle diameter of the molecular clusters is reduced to a nano-scale.

The [symbol] shape is also called a left-handed swastika shape, a left-handed fylfot shape, a swavastika shape or a sauvastika shape. Meanwhile, the [symbol] shape is also called a right-handed swastika shape, a right-handed fylfot shape or a swastika shape.

In one embodiment of the present invention, the amount of the first stirring blade is between one and three, while the amount of the second stirring blade is between one and three.

In one embodiment of the present invention, a height difference is defined between the first stirring blade and the second stirring blade.

In one embodiment of the present invention, the first stirring blade includes a shaft connection portion, four L-shape upright plates and four L-shape lower plates, all of which construct a [symbol] shape (or [symbol] shape) blade structure, while the second stirring blade includes a shaft connection portion, four L-shape upright plates and four L-shape upper plates, all of which construct a [symbol] shape (or [symbol] shape) blade structure.

In one embodiment of the present invention, each of the L-shape upright plates of the first stirring blade has an outer edge formed with a flow guiding surface, while each of the L-shape upright plates of the second stirring blade has an outer edge formed with another flow guiding surface.

In one embodiment of the present invention, a shear flow notch is defined between an end edge of each of the L-shape lower plates of the first stirring blade and a circumference surface of the shaft connection portion of the first stirring blade, while another shear flow notch is defined between an end edge of each of the L-shape upper plates of the second stirring blade and a circumference surface of the shaft connection portion of the second stirring blade.

In one embodiment of the present invention, the L-shape upright plates and the L-shape lower plates of the first stirring blade construct the [symbol] shape blade structure to push the liquid along a clockwise direction to flow upward under high stirring speed, while the L-shape upright plates and the L-shape upper plates of the second stirring blade construct the [symbol] shape blade structure to push the liquid along a counterclockwise direction to flow downward under high stirring speed.

In one embodiment of the present invention, the L-shape upright plates and the L-shape lower plates of the first stirring blade construct the [symbol] shape blade structure to push the liquid along a counterclockwise direction to flow upward under high stirring speed, while the L-shape upright plates and the L-shape upper plates of the second stirring blade construct the [symbol] shape blade structure to push the liquid along a clockwise direction to flow downward under high stirring speed.

In one embodiment of the present invention, the L-shape upright plates and the L-shape lower plates of the first stirring blade construct the [symbol] shape blade structure to push the liquid along a clockwise direction to flow upward under high stirring speed, while the L-shape upright plates and the L-shape upper plates of the second stirring blade construct the [symbol] shape blade structure to push the liquid along a clockwise direction to flow downward under high stirring speed.

In one embodiment of the present invention, the L-shape upright plates and the L-shape lower plates of the first stirring blade construct the [symbol] shape blade structure to push the liquid along a counterclockwise direction to flow upward under high stirring speed, while the L-shape upright plates and the L-shape upper plates of the second stirring blade construct the [symbol] shape blade structure to push the liquid along a counterclockwise direction to flow downward under high stirring speed.

In one embodiment of the present invention, the stirring tank is further connected to a pressurization device for pressurizing the liquid in the stirring chamber.

In one embodiment of the present invention, the first driving unit is a high speed motor, while the second driving unit is a high speed motor.

In one embodiment of the present invention, the stirring tank, the first shaft, the first stirring blade, the second shaft and the second stirring blade are made of stainless steel.

In one embodiment of the present invention, the stirring chamber has an inner bottom which is provided with a plurality of projections.

### DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a vertically cross-sectional view of a device for processing molecular clusters of liquid to nano-scale according to a first embodiment of the present invention;

FIG. 2 is a horizontally cross-sectional view of the device for processing molecular clusters of liquid to nano-scale according to the first of the present invention;

FIG. 3A is a perspective view of a first stirring blade according to the first embodiment of the present invention;

FIG. 3B is a perspective view of a second stirring blade according to the first embodiment of the present invention;

FIG. 4 is a vertically cross-sectional view of a device for processing molecular clusters of liquid to nano-scale according to a second embodiment of the present invention;

FIG. 5 is a vertically cross-sectional view of a device for processing molecular clusters of liquid to nano-scale according to a third embodiment of the present invention; and

FIG. 6 is a horizontally cross-sectional view of a device for processing molecular clusters of liquid to nano-scale according to a fourth embodiment of the present invention.

### DETAILED DESCRIPTION OF THE PREFERRED EMBODIMENTS

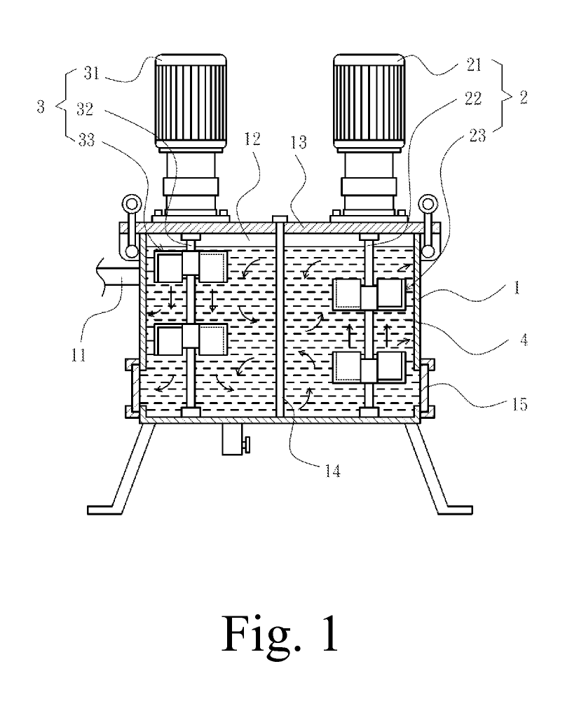

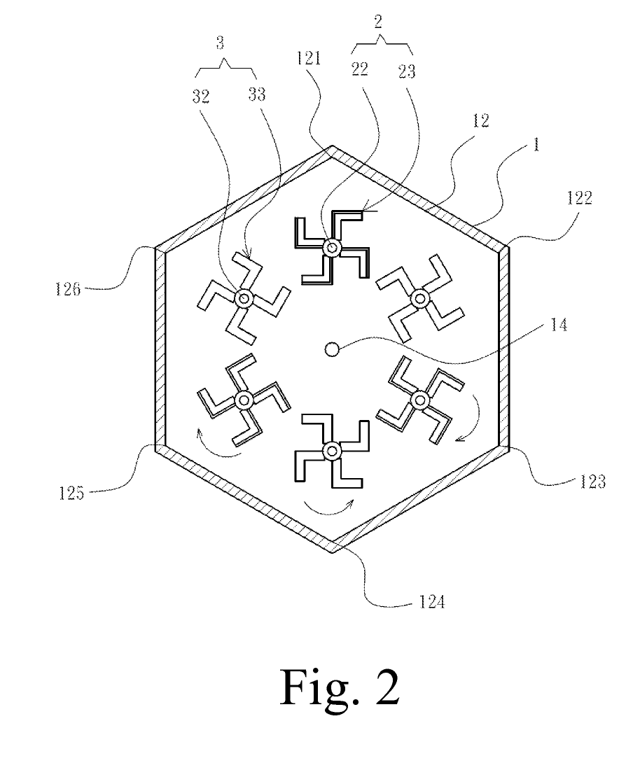

Referring now to FIGS. 1 and 2, a device for processing molecular clusters of liquid to nano-scale according to a first embodiment of the present invention is illustrated. As shown, the device comprises a stirring tank 1, three first stirring modules 2 and three second stirring modules 3, wherein the device is used to cause molecular clusters of a liquid 4 to collide with each other at high speed, in order to break the original molecular clusters with greater particle diameter into smaller molecular clusters with smaller nano-scale particle diameter. The liquid 4 of the present invention is exemplified by water hereinafter, but the liquid 4 is not limited to water, wherein the liquid 4 can be other inorganic or organic liquid, colloid or suspension, such as various edible oils, essential oils and etc. The type of the liquid 4 is not a limitation of the device of the present invention.

Referring to FIGS. 1 and 2, in the first embodiment of the present invention, the stirring tank 1 is preferably made of inert material, such as stainless steel, wherein the stirring tank 1 has a liquid inlet 11, a stirring chamber 12, a lid 13, a fixation rod 14 and at least one inspection window 15. In the present invention, the liquid inlet 11 can be formed at any suitable position, such as a side wall of the stirring tank 1 or the lid 13. The liquid inlet 11 is used to input the liquid 4 selected from water or other inorganic or organic liquid, colloid or suspension. In one embodiment, the liquid inlet 11 of the present invention can be omitted, and the liquid 4 can be poured into the stirring chamber 12 when the lid 13 is opened. The stirring chamber 12 is defined in the stirring tank 1, and the stirring chamber 12 is a hexagonal space, preferably a hexagonal column space of regular hexagon. The stirring chamber 12 is used to receive the liquid 4, and the stirring chamber 12 can be preferably 70 percent full of the liquid 4, but not limited thereto. In the present invention, the stirring tank 1 is preferably further connected to a pressurization device (not shown) for pressurizing the liquid 4 in the stirring chamber 12. For example, a pressure about 5-10 kg/cm² can be selectively provided to enhance the processing efficiency of the following collision and break of molecular clusters of the liquid 4. In addition, the lid 13 can be fixed over the stirring chamber 12 by the fixation rod 14 or other suitable connection elements (unlabeled), so that the stirring chamber 12 can be optionally opened or closed by the lid 13. The foregoing connection elements can be preferably screwing elements, pivotal elements, fasteners, O-rings or other equivalent elements. The fixation rod 14 has a first end passing through and connected to a central position of the lid 13, and a second end connected to a bottom of the stirring chamber 12. The at least one inspection window 15 is disposed on any suitable position, such as a side wall of the stirring tank 1 or the lid 13. The inspection window 15 has a transparent glass plate or plastic plate for an operator to externally inspect the stirring status in the stirring chamber 12.

Referring to FIGS. 1, 2 and 3A, in the first embodiment of the present invention, the three first stirring modules 2 are correspondingly arranged on three positions close to a first angular position 121, a third angular position 123, and a fifth angular position 125 of the stirring chamber 12, respectively. Each of the first stirring modules 2 has a first driving unit 21, a first shaft 22 and at least one first stirring blade 23. The first driving unit 21 is preferably a high speed motor, such as a high speed motor having a rotation speed greater than 2000 rpm (revolutions per minute). The first shaft 22 and the first stirring blade 23 are preferably made of inert material, such as stainless steel. The first shaft 22 has a first end connected to the first driving unit 21, and a second end rotatably mounted on an inner bottom of the stirring chamber 12. In the present invention, the first driving unit 21 can be used to drive the first stirring blade 23 to rotate through the first shaft 22, so as to push the liquid 4 to flow along a first direction under high stirring speed. For example, the liquid 4 can longitudinally flow upward under high stirring speed.

Referring still to FIGS. 1, 2 and 3A, in the first embodiment of the present invention, the first stirring blade 23 comprises a shaft connection portion 231, four L-shape upright plates 232 and four L-shape lower plates 233, all of which construct a [symbol] shape blade structure from a top view of FIG. 2 to push the liquid 4 along a clockwise direction to longitudinally flow upward and radially flow outward under high stirring speed. The [symbol] shape is also called a left-handed swastika shape, a left-handed fylfot shape, a swavastika shape or a sauvastika shape, from a top view of FIG. 2. The shaft connection portion 231 is a hollow column having a through hole (unlabeled) therein, wherein the first shaft 22 can pass through the through hole thereof. Each of the L-shape upright plates 232 has a L-shape transverse cross-section, and is longitudinally and uprightly connected to a circumference surface of the shaft connection portion 231 by suitable means (such as welding or integral forming). A 90 degree angle is included between positions of each two of the adjacent L-shape upright plates 232. Each of the L-shape upright plates 232 of the first stirring blade 23 has an outer edge which is preferably formed with a flow guiding surface 234, wherein the flow guiding surface 234 can be selected from a curved surface or an inclination surface for guiding the liquid 4 to be smoothly pushed by the L-shape upright plates 232, so that the liquid 4 can be stirred. In addition, each of the L-shape lower plates 233 is a L-shape planar plate, and is transversely and horizontally connected to a lower edge of each of the L-shape upright plates 232 by suitable means (such as welding or integral forming). The L-shape lower plates 233 are used to push the liquid 4 to longitudinally flow upward. In one embodiment, each of the L-shape lower plates 233 has an end edge connected to the circumference surface of the shaft connection portion 231 of the first stirring blade 23 by suitable means (such as welding or integral forming), while a shear flow notch 235 is preferably defined between the end edge of each of the L-shape lower plates 233 of the first stirring blade 23 and the circumference surface of the shaft connection portion 231 of the first stirring blade 23. Thus, when the liquid 4 is rotated and stirred, the liquid 4 can flow through the shear flow notch 235 to suitably form a shear flow, so as to increase the frequency of disturbance and collision.

Referring now to FIGS. 1, 2 and 3B, in the first embodiment of the present invention, the structure and design principle of the three second stirring modules 3 are substantially similar to that of the three first stirring modules 2, wherein the three second stirring modules 3 are correspondingly arranged on three positions close to a second angular position 122, a fourth angular position 124, and a sixth angular position 126 of the stirring chamber 12, respectively. In other words, the three second stirring modules 3 are alternatively arranged with the three first stirring modules 2. Each of the second stirring modules 3 has a second driving unit 31, a second shaft 32 and at least one second stirring blade 33. The second driving unit 31 and the second shaft 32 are substantially similar to the first driving unit 21 and the first shaft 22. In the present invention, the second driving unit 31 can be used to drive the second stirring blade 33 to rotate through the second shaft 32, so as to push the liquid 4 to flow along a second direction under high stirring speed. For example, the liquid 4 can longitudinally flow downward and radially flow outward under high stirring speed.

Referring still to FIGS. 1, 2 and 3B, in the first embodiment of the present invention, the second stirring blade 33 are substantially similar to the first stirring blade 23, wherein the second stirring blade 33 comprises a shaft connection portion 331, four L-shape upright plates 332 and four L-shape upper plates 333, all of which construct a [symbol] shape blade structure from a top view of FIG. 2 to push the liquid 4 along a counterclockwise direction to longitudinally flow downward and radially flow outward under high stirring speed. The [symbol] shape is also called a right-handed swastika shape, a right-handed fylfot shape or a swastika shape, from a top view of FIG. 2. The shaft connection portion 331 is a hollow column having a through hole (unlabeled) therein, wherein the second shaft 32 can pass through the through hole thereof. Each of the L-shape upright plates 332 is longitudinally and uprightly connected to a circumference surface of the shaft connection portion 331. A 90 degree angle is included between positions of each two of the adjacent L-shape upright plates 332. Each of the L-shape upright plates 332 of the second stirring blade 33 has an outer edge which is preferably formed with a flow guiding surface 334, wherein the flow guiding surface 334 can be selected from a curved surface or an inclination surface for guiding the liquid 4 to be smoothly pushed by the L-shape upright plates 332, so that the liquid 4 can be stirred. In addition, each of the L-shape upper plates 333 is an L-shape planar plate, and is transversely and horizontally connected to an upper edge of each of the L-shape upright plates 332. The L-shape upper plates 333 are used to push the liquid 4 to longitudinally flow downward. In one embodiment, each of the L-shape upper plates 333 has an end edge connected to the circumference surface of the shaft connection portion 331 of the second stirring blade 33 by suitable means (such as welding or integral forming), while a shear flow notch 335 is preferably defined between the end edge of each of the L-shape upper plates 333 of the second stirring blade 33 and the circumference surface of the shaft connection portion 331 of the second stirring blade 33. Thus, when the liquid 4 is rotated and stirred, the liquid 4 can flow through the shear flow notch 335 to suitably form a shear flow, so as to increase the frequency of disturbance and collision.

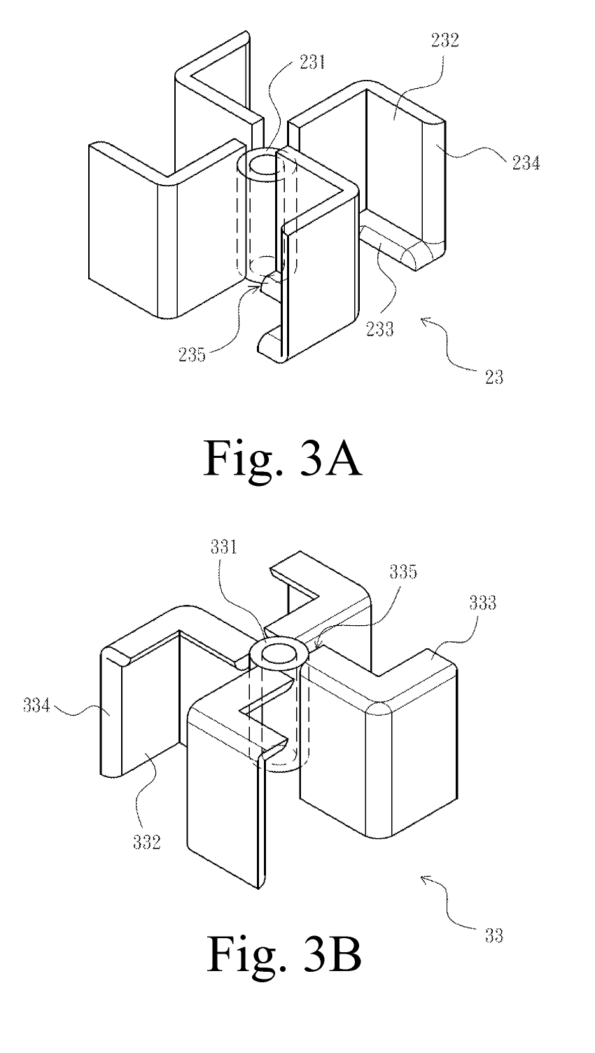

Referring back to FIGS. 3A and 3B, in the first embodiment of the present invention, the first stirring blade 23 comprises the four L-shape lower plates 233 to construct a [symbol] shape blade structure from a top view of FIG. 2 for pushing the liquid 4 along a clockwise direction to longitudinally flow upward and radially flow outward under high stirring speed. Meanwhile, the second stirring blade 33 comprises the four L-shape upper plates 333 to construct a [symbol] shape blade structure from a top view of FIG. 2 for pushing the liquid 4 along a counterclockwise direction to longitudinally flow downward and radially flow outward under high stirring speed. However, in other embodiments of the present invention, only if the first stirring blade 23 and the second stirring blade 33 can cause the liquid 4 to flow along two opposite directions under high stirring speed, the blade structure and the rotation direction of the first stirring blade 23 and the second stirring blade 33 from a top view of FIG. 2 can be suitably interchanged with each other. For example, in one embodiment, the first stirring blade 23 can construct a top-view [symbol] shape blade structure (not-shown) for pushing the liquid 4 along a counterclockwise direction to longitudinally flow upward and radially flow outward under high stirring speed. Meanwhile, the second stirring blade 33 can construct a top-view [symbol] shape blade structure (not-shown) for pushing the liquid 4 along a clockwise direction to longitudinally flow downward and radially flow outward under high stirring speed. In another embodiment, the first stirring blade 23 can construct a top-view [symbol] shape blade structure (not-shown) for pushing the liquid 4 along a clockwise direction to longitudinally flow upward and radially flow outward under high stirring speed. Meanwhile, the second stirring blade 33 can construct a top-view [symbol] shape blade structure (not-shown) for pushing the liquid 4 along a clockwise direction to longitudinally flow downward and radially flow outward under high stirring speed. In further another embodiment, the first stirring blade 23 can construct a top-view [symbol] shape blade structure (not-shown) for pushing the liquid 4 along a counterclockwise direction to longitudinally flow upward and radially flow outward under high stirring speed. Meanwhile, the second stirring blade 33 can construct a top-view [symbol] shape blade structure (not-shown) for pushing the liquid 4 along a counterclockwise direction to longitudinally flow downward and radially flow outward under high stirring speed. The various foregoing embodiments are possible implements of the present invention.

Referring now to FIGS. 1, 2, 3A and 3B, when the device of the first embodiment of the present invention is used, the liquid 4 (such as purified water) is firstly inputted into the hexagonal stirring chamber 12 from the liquid inlet 11, wherein the stirring chamber 12 is 70 percent full of the liquid 4 therein to maintain a suitable liquid/air mixing ratio after the following stirring operation. Then, a pressurization device (not shown) is used for pressurizing the liquid 4 in the stirring chamber 12. For example, a pressure about 5-10 kg/cm² can be selectively provided to enhance the processing efficiency of the following collision and break of molecular clusters of the liquid 4. After this, the first and second driving units 21, 31 are started to drive the first and second stirring blades 23, 33, respectively. In the embodiment, the first stirring blade 23 comprises the four L-shape lower plates 233 to construct a [symbol] shape blade structure from a top view of FIG. 2 for pushing the liquid 4 along a clockwise direction to longitudinally flow upward and radially flow outward under high stirring speed. Meanwhile, the second stirring blade 33 comprises the four L-shape upper plates 333 to construct a [symbol] shape blade structure from a top view of FIG. 2 for pushing the liquid 4 along a counterclockwise direction to longitudinally flow downward and radially flow outward under high stirring speed. Under high pressure in the stirring chamber 12, the first and second stirring blades 23, 33 push the liquid 4 to flow upward and downward under high stirring speed, so that the water molecular clusters of the liquid 4 can be collided with each other to generate high temperature which can be greater than 100° C. (i.e. boiling point). Moreover, the hexagonal stirring chamber 12 of the present invention is advantageous to increase the stirring uniformity of the high temperature, high pressure and high stirring speed therein. After stirring a predetermined time, the water molecular clusters of the liquid 4 will be broken into smaller molecular clusters with smaller particle diameter, i.e. the amount of linked water molecules in each molecular cluster can be reduced. Thus, the molecular clusters of the liquid 4 (such as purified water or other liquid) can be processed to nano-scale, so as to enhance the physical and chemical properties of the nano-scale liquid 4, and advantageously carry out the mass production of nano-scale liquid 4.

In the first embodiment of the present invention, after the liquid 4 (purified water) is processed by the device of the present invention, the particle diameter of the molecular clusters of the liquid 4 can be analyzed by N4 Plus Submicron Particle Size Analyzer (Beckman Coulter, U.S.A.). The average particle diameter of the molecular clusters of the processed liquid 4 (purified water) is almost 100 percent reduced to about 50.6 nm. In comparison, if a stirring device having other stirring blades without a hexagonal stirring chamber and a special blade arrangement is used to process the liquid 4 (purified water), the particle diameter of the molecular clusters of the processed liquid 4 (purified water) is only 17.06 percent reduced to about 71.3 nm, and the particle diameter of the molecular clusters of the remaining liquid 4 (82.94%) is still about 4258.4 nm. After a plurality of simulation experiments, the present invention found that the structure design of the three first stirring blades 23 and the three second stirring blades 33 alternatively arranged on six angular positions 121-126 of the hexagonal stirring chamber 12 can provide better efficiency for processing molecular clusters of the liquid 4 to nano-scale. Thus, the device of the present invention can be useful to reduce the amount of linked water molecules in each molecular cluster of the liquid 4 and to lower the particle diameter of the molecular clusters thereof, so that the physical and chemical properties including permeability, solubility and dissolved oxygen of the liquid 4 are increased, while the pH value thereof can be changed from 10 to 12. Therefore, the processed liquid 4 can be easily absorbed and used by human body for improving nutrients absorption and metabolic cycle therein. The nano-scale processed liquid 4 can be applied to related products of various technological fields, such as drinking water, medicine, cosmetics, diet products, health foods, alcohols and cleaners.

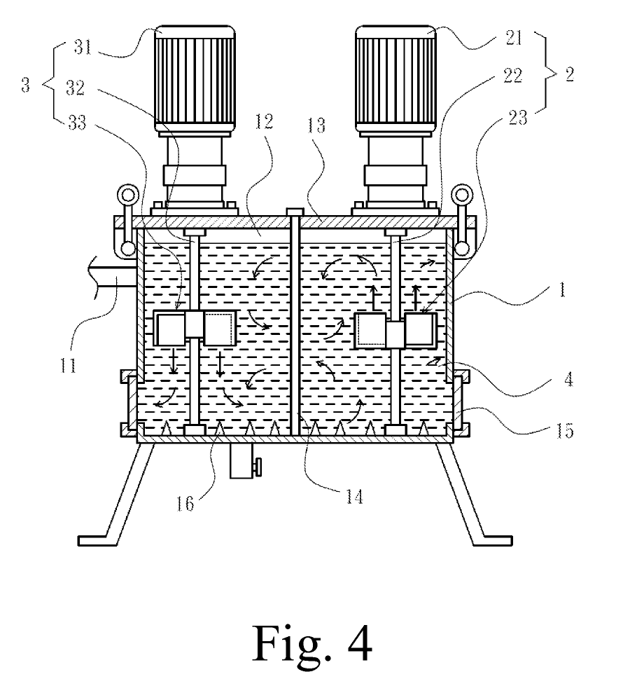

Referring now to FIG. 4, a device for processing molecular clusters of liquid to nano-scale according to a second embodiment of the present invention is illustrated and similar to the first embodiment, so that the second embodiment uses similar numerals of the first embodiment. As shown, the device of the second embodiment is characterized in that each of the first stirring modules 2 of the second embodiment is provided with a single first stirring blade 23, while each of the second stirring modules 3 of the second embodiment is provided with a single second stirring blade 33. Thus, the hexagonal stirring chamber 12 still can be matched with the first stirring blade 23 and the second stirring blade 33 for processing molecular clusters of the liquid 4 to nano-scale. In comparison, although the processing time of stirring is relatively increased, the second embodiment is further advantageous to relatively lower the purchase or maintenance cost of the entire device thereof. Furthermore, in the embodiment, the stirring chamber 12 has an inner bottom which is selectively provided with a plurality of projections 16, such as knife blades or nails with suitable shape. The projections 16 are used to relatively increase the efficiency of stirring the liquid 4 and to enhance the collision and break frequency of water molecular clusters of the liquid 4.

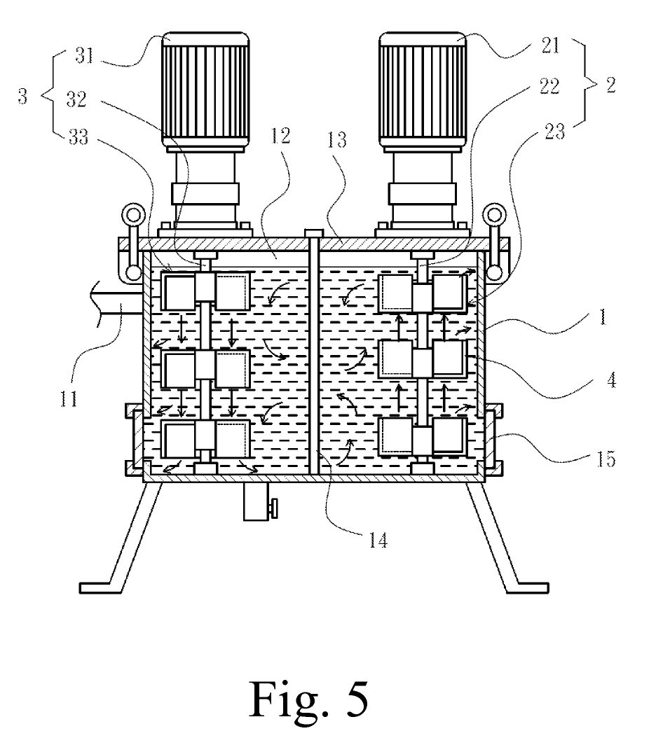

Referring now to FIG. 5, a device for processing molecular clusters of liquid to nano-scale according to a third embodiment of the present invention is illustrated and similar to the first and second embodiments, so that the third embodiment uses similar numerals of the first embodiment. As shown, the device of the third embodiment is characterized in that each of the first stirring modules 2 of the second embodiment is provided with three or more first stirring blades 23, while each of the second stirring modules 3 of the second embodiment is provided with three or more second stirring blades 33. Thus, the hexagonal stirring chamber 12 still can be matched with the first stirring blades 23 and the second stirring blades 33 for processing molecular clusters of the liquid 4 to nano-scale. In comparison, although the purchase or maintenance cost of the entire device is relatively increased, the second embodiment is further advantageous to relatively lower the processing time of stirring. According to the second and third embodiments, the present invention can adjust the installation amount of the first stirring blades 23 and the second stirring blades 33 according to actual desire of manufacture. In addition, the installation amount of the first stirring blades 23 can be different from that of the second stirring blades 33 according to other implement of the present invention.

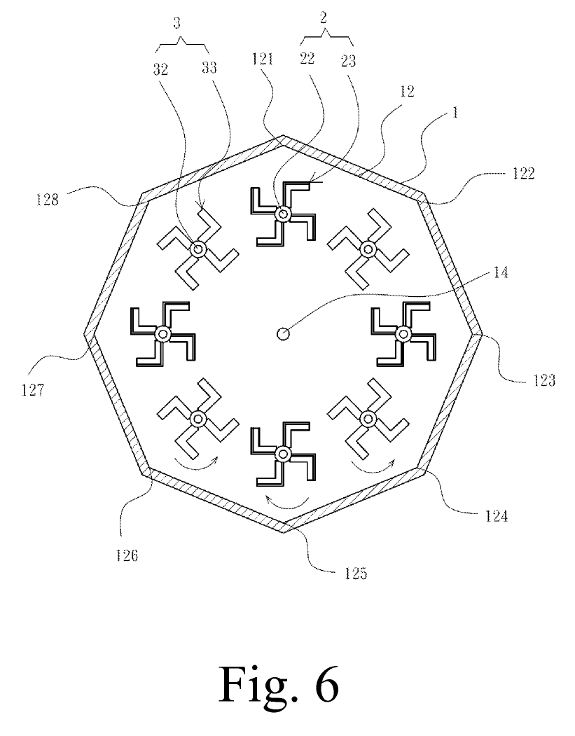

Referring now to FIG. 6, a device for processing molecular clusters of liquid to nano-scale according to a fourth embodiment of the present invention is illustrated and similar to the first, second and third embodiments, so that the fourth embodiment uses similar numerals of the first embodiment. As shown, the device of the fourth embodiment is characterized in that the stirring chamber 12 has an octagonal column space provided with four first stirring modules 2 and four second stirring modules 3. The four first stirring modules 2 are correspondingly arranged on four positions close to a first angular position 121, a third angular position 123, a fifth angular position 125 and a seventh angular position 127 of the stirring chamber 12, respectively. Meanwhile, the four second stirring modules 3 are correspondingly arranged on four positions close to a second angular position 122, a fourth angular position 124, a sixth angular position 126 and a eighth angular position 128 of the stirring chamber 12, respectively. Each of the first stirring modules 2 can selectively comprise one, two, three or more first stirring blade 23, while each of the second stirring modules 3 can selectively comprise one, two, three or more second stirring blade 33. Moreover, the stirring chamber 12 has an inner bottom which is selectively provided with a plurality of projections 16 (as shown in FIG. 4), such as knife blades or nails with suitable shape. As a result, the octagonal stirring chamber 12 still can be matched with the first stirring blades 23 and the second stirring blades 33 for processing molecular clusters of the liquid 4 to nano-scale. In comparison, although the purchase or maintenance cost of the entire device is relatively increased, the fourth embodiment is further advantageous to relatively lower the processing time of stirring.

As described above, according to the traditional collision processing device for processing water molecular clusters to nano-scale water, the minimum particle diameter of the molecular clusters of the nano-scale water is only about 200 nm, while the traditional collision processing device can not carry out the mass production of nano-scale water and can not efficiently increase the ratio of smaller molecular clusters in the nano-scale water. In comparison, according to the device for processing molecular clusters of liquid to nano-scale of the present invention as shown in FIGS. 2 to 6, the stirring chamber 12 has a hexagonal (or octagonal) column space, while the first and second stirring blades having a [symbol] shape or a [symbol] shape are alternatively arranged with each other and located at different heights. Thus, the device can efficiently increase the collision frequency of molecular clusters of the liquid 4. Under high pressure in the stirring chamber 12, the first and second stirring blades 23, 33 push the liquid 4 to flow upward and downward under high stirring speed, so that the water molecular clusters of the liquid 4 can be collided with each other to generate high temperature which can be greater than 100° C. (i.e. boiling point), so as to advantageously reduce the amount of linked water molecules and the particle size of the molecular clusters for processing the molecular clusters of the liquid to nano-scale (about 50.6 nm). Thus, a nano-scale liquid having better physical and chemical properties can be obtained, and the mass production of nano-scale liquid can be carried out.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A device for processing molecular clusters of liquid to nano-scale, comprising:
a stirring tank having a liquid inlet for inputting a liquid and a hexagonal or octagonal stirring chamber for receiving the liquid;
a plurality of first stirring modules, each of which has a first driving unit, a first shaft and at least one first stirring blade, wherein the first stirring blade has a left-handed swastika shape or right-handed swastika shape, and the first driving unit is used to drive the first stirring blade to rotate for pushing the liquid to flow along a first direction under high stirring speed through the first shaft; and
a plurality of second stirring modules, each of which has a second driving unit, a second shaft and at least one second stirring blade, wherein the second stirring blade has a right-handed swastika shape or left-handed swastika shape, and the second driving unit is used to drive the second stirring blade to rotate for pushing the liquid to flow along a second direction opposite to the first direction under high stirring speed through the second shaft;
wherein the first stirring modules and the second stirring modules are alternatively arranged on a plurality of angular positions in the stirring chamber, respectively.

2. The device for processing molecular clusters of liquid to nano-scale according to claim 1, wherein the amount of the first stirring blade is between one and three, while the amount of the second stirring blade is between one and three.

3. The device for processing molecular clusters of liquid to nano-scale according to claim 1, wherein a height difference is defined between the first stirring blade and the second stirring blade.

4. The device for processing molecular clusters of liquid to nano-scale according to claim 1, wherein the first stirring blade includes a shaft connection portion, four L-shape upright plates and four L-shape lower plates, all of which construct a left-handed swastika shape or right-handed swastika shape blade structure, while the second stirring blade includes a shaft connection portion, four L-shape upright plates and four L-shape upper plates, all of which construct a right-handed swastika shape or left-handed swastika shape blade structure.

5. The device for processing molecular clusters of liquid to nano-scale according to claim 4, wherein each of the L-shape upright plates of the first stirring blade has an outer edge formed with a flow guiding surface, while each of the L-shape upright plates of the second stirring blade has an outer edge formed with another flow guiding surface.

6. The device for processing molecular clusters of liquid to nano-scale according to claim 4, wherein a shear flow notch is defined between an end edge of each of the L-shape lower plates of the first stirring blade and a circumference surface of the shaft connection portion of the first stirring blade, while another shear flow notch is defined between an end edge of each of the L-shape upper plates of the second stirring blade and a circumference surface of the shaft connection portion of the second stirring blade.

7. The device for processing molecular clusters of liquid to nano-scale according to claim 4, wherein the L-shape upright plates and the L-shape lower plates of the first stirring blade construct the left-handed swastika shape blade structure to push the liquid along a clockwise direction to flow upward under high stirring speed, while the L-shape upright plates and the L-shape upper plates of the second stirring blade construct the right-handed swastika shape blade structure to push the liquid along a counterclockwise direction to flow downward under high stirring speed.

8. The device for processing molecular clusters of liquid to nano-scale according to claim 4, wherein the L-shape upright plates and the L-shape lower plates of the first stirring blade construct the right-handed swastika shape blade structure to push the liquid along a counterclockwise direction to flow upward under high stirring speed, while the L-shape upright plates and the L-shape upper plates of the second stirring blade construct the left-handed swastika shape blade structure to push the liquid along a clockwise direction to flow downward under high stirring speed.

9. The device for processing molecular clusters of liquid to nano-scale according to claim 4, wherein the L-shape upright plates and the L-shape lower plates of the first stirring blade construct the left-handed swastika shape blade structure to push the liquid along a clockwise direction to flow upward under high stirring speed, while the L-shape upright plates and the L-shape upper plates of the second stirring blade construct the left-handed swastika shape blade structure to push the liquid along a clockwise direction to flow downward under high stirring speed.

10. The device for processing molecular clusters of liquid to nano-scale according to claim 4, wherein the L-shape upright plates and the L-shape lower plates of the first stirring blade construct the right-handed swastika shape blade structure to push the liquid along a counterclockwise direction to flow upward under high stirring speed, while the L-shape upright plates and the L-shape upper plates of the second stirring blade construct the right-handed swastika shape blade structure to push the liquid along a counterclockwise direction to flow downward under high stirring speed.

11. The device for processing molecular clusters of liquid to nano-scale according to claim 1, wherein the stirring tank is further connected to a pressurization device for pressurizing the liquid in the stirring chamber.

12. The device for processing molecular clusters of liquid to nano-scale according to claim 1, wherein the first driving unit is a high speed motor, while the second driving unit is a high speed motor.

13. The device for processing molecular clusters of liquid to nano-scale according to claim 1, wherein the stirring tank, the first shaft, the first stirring blade, the second shaft and the second stirring blade are made of stainless steel.

14. The device for processing molecular clusters of liquid to nano-scale according to claim 1, wherein the stirring chamber has an inner bottom which is provided with a plurality of projections.
